(19) United States
(12) Patent Application Publication
(10) Pub. No.: US 2013/0218785 A1
(43) Pub. Date: Aug. 22, 2013

(54) SELF ASSEMBLY OF PATENT APPLICATIONS

(71) Applicant: Randall William Marusyk, Ottawa (CA)

(72) Inventor: Randall William Marusyk, Ottawa (CA)

(21) Appl. No.: 13/624,685

(22) Filed: Sep. 21, 2012

Related U.S. Application Data
(60) Provisional application No. 61/538,753, filed on Sep. 23, 2011.

(51) Int. Cl. G06Q 50/18; G06F 17/24

(52) U.S. Cl. CPC G06Q 50/184; G06F 17/24
USPC 705/310

(57) ABSTRACT

The present invention relates to a process and related product that is in the field of self assembly documents. More specifically, the present invention involves a self assembled patent application that can either be filed automatically after the assembly has occurred, or sent to a patent professional for review prior to filing.

### CROSS REFERENCE TO RELATED APPLICATION(S)

This application claims the benefit of priority under 35 U.S.C. §119(e) of U.S. Patent Application No. 61/538,753 filed Sep. 23, 2011.

### FIELD OF THE INVENTION

The present invention relates to the field of self assembling documents.

### BACKGROUND OF THE INVENTION

The field of self assembling documents is known in the art. More specifically, it has become a trend in the service industry to have a document traditionally prepared manually by a given service provider. Such examples of self assembly are the preparation of tax returns via a series of questions, typically performed by a piece of software installed on a computer or more recently via a web based site whether such program is based on a server or operating via cloud computing.

More recently, the field of law has begun to embrace the process of self assembly of legal documents. Legal documents such as wills, divorces, simple contracts have been offered to the consuming public for a price or at times for free. This has led to the commodification of these areas of law, requiring service providers to adapt their practices accordingly. A popular trend in self assembling legal documents is to have the end users answer a series of questions in as much detail such that it is leading to a full or partial commodification of a legal document. The document once assembled can be used without further modification or can be reviewed by a lawyer, a paralegal, or the like for post assembly modification for the end user's use.

Other forms of self assembly have also entered the legal profession such as e-Discovery whereby the review of sometimes millions of documents can be sorted and elevated as to their relevance once the parameters are set, lowering the costs of document review in litigation to a fraction of the costs.

The field of intellectual property has not escaped exposure to self assembling of legal documents. Electronic and automated trademark filing services exist where the consumer of trademark legal services answers a series of questions that results in a trademark application that can be immediately filed, or sent to a trademark lawyer, paralegal or the like for review prior to filings.

However, the field of patent drafting has remained a labor intensive and non-commodified process. This results in a process and a product that is expensive and slow to produce. The domestic laws of almost all countries as well as international treaties favor what is known as a First to File novelty system. This system awards a patent to the inventor who first files a patent application and not the person who first invents. As such, the current process of drafting and filing a patent application typically takes weeks if not months to prepare, exposing the consumer of patent drafting service to being “scooped” by another inventor who may have invented after the first inventor but filed first. Additionally, consumers of patent drafting and filing services often express frustration that the service provider does not fully understand the invention which sometimes results in the resulting patent not covering the invention or exposing the patent to invalidity due to some legal issue.

Moreover, prior to drafting a patent application, the consumer often carries out what is known in the art as a prior art search to determine if the invention to be patented is novel, has an inventive step and is patentable subject matter. While this step is not required prior to a filing a patent application, it is often carried out in order to educate the consumer of what other inventors have sought in the past. This process is historically cumbersome, expensive, and slow, as the compilation of prior art through key word searching, or patent class searching, followed by manual analysis of each uncovered piece of art to determine its relevance. Advancements in this area have been made over the past years to automate this process to lower costs and give a higher degree of comfort to inventors that no one has previously filed patent protection in a given area. This process can be applied to non-patent prior art as well as patent prior art. Such searches are done to determine either patentability of an invention vis-à-vis any novelty barring prior art as well as patent prior art that could prevent the inventor from working the invention due to another 3^{rd} party's patented invention. This latter search is done to determine whether one has the freedom to operate.

The present invention overcomes the expenses and slowness of the patent drafting and filing process by providing a novel patent application self assembly process and/or a filing process.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present invention involves a consumer of patent legal services following the steps of engaging the patent self assembly service provider either prior to or after engaging the formal patent drafting process. The present invention relates to a process whereby a consumer of patent draft services engages a software means, follows a series of questions that once completed generates a draft patent application.

### DETAILED DESCRIPTION OF THE INVENTION

### Definitions

Unless defined otherwise, all technical and scientific terms used herein have the same meaning as commonly understood by one of ordinary skill in the art to which this invention belongs.

The self assembly of patent application involves the following novel process.

(1) Engaging the service provider's self assembly software,

(2) Answering subroutine questions relating to the inventorship and ownership,

(3) Answering subroutine questions to identifying the field of invention,

(4) Answering subroutine questions to identify what is known in the art and why is the invention different from prior art,

(5) Answering subroutine questions to identify what is the objective of the invention, what is the problem to be solved by the invention, how does the invention overcome existing problems in the art, and whether it is a device, a method of production or a use.

(6) Answering additional sub-routine questions that are specific to one or more fields of invention;

(7) Repeating Steps 3 to 6 as many times as necessary until further sub-routine questions are exhausted;

(8) Assembling the patent application based on the information obtained from steps 1 to 7.

One embodiment of the present invention would involve the inventor of a new cDNA that has a certain activity in the regulation of cancer. The inventor would engage the self assembly software (1), place all of his personal information required in the normal filing of a patent application (2). The inventor would then enter the field of invention as a gene based patent (3). The software would then run the sub-routine question to identify prior art and prompting the inventor to identify differences between the invention and the prior art (4). The software would then run the sub-routine questions on gene based patents and ask a series of questions such as the construction of the vehicle containing the cDNA, the disease or condition the gene is directed to, the type of possible use of the gene to relieve, treat, or modify the disease or condition, condition in which the gene is expressed, or other issues such as production, modifications, etc. (5-7). The software would take this information and automatically assemble the appropriate paragraphs, sections and the like that are common to all gene based patents, producing a draft patent application (8). Given the point of novelty of such a gene patent application is the cDNA itself, questions regarding the specificity and uniqueness of the gene would be entered in the subroutine questions.

Another embodiment of the present invention would involve the inventor of a novel service for an online social network. The inventor would engage the self assembly software (1) and place all of his personal information required in the normal filing of a patent application (2). The inventor would then enter the field of invention as a method of processing social network data via software (3). The software would then run the sub-routine question to identify prior art and prompting the inventor to identify differences between the invention and the prior art (4). The self assembly software would the run the sub-routine questions on software and social networking and ask a series of questions such as the information needed from the social network vehicle for the novel service, the interaction of the novel service with the vehicle for service delivery, the operations done by the novel service on the information drawn from the social network, the output and the means to generate an output to the user of the social network or the social network (5-7). The interaction of the social network subroutine and the software subroutine would cause the subroutines to pose questions to the inventor to ensure that the resulting self assembled patent application would not be limited to a single social network architecture but would account for various architectures. The software would take this information and automatically assemble the appropriate paragraphs, sections and the like that are common to software and social-network based patents, producing a draft patent application (8).

Another embodiment of the present invention would involve the inventor of a new method of manufacturing a novel drug for use in the treatment of pain. The inventor would engage the self assembly software (1) and place all of his personal information required in the normal filing of a patent application (2). The inventor would then enter the field of invention as a method of manufacturing a novel drug for use in the treatment of pain (3).). The software would then run the sub-routine question to identify prior art and prompting the inventor to identify differences between the invention and the prior art (4). The self assembly software would the run the sub-routine questions on pharmaceutical manufacturing and pharmaceutical formulations and ask a series of questions such as the possible formulations, the possible concentrations, the possible dosage regimes, the essential constituent elements, the possible constituent elements, the methodology to produce the formulations (5-7). The interaction of the pharmaceutical manufacturing and pharmaceutical formulations subroutines would cause the resulting self assembled patent application to include all permutations or formulations, concentrations and dosage regimes (8).

The consumer could either review the self assembled draft patent application themselves prior to filing or simply file it once all the questions are completed or could send it to a qualified patent agent or attorney for a review prior to filing.

The consumer could be prompted to enter payment information, either by way of credit card information or any form of electronic or other payment methods, whether direct or indirect, before beginning the process, incurring a fee for using the process and allowing the payment information to be used in the payment of government fees relating to the filing of patent applications.

The generation of sub-routines questions that result in either the self assembly of paragraphs, sections and the like from the answers entered could result in the self assembly being complete or leading to another set of sub-routine questions unique to the field of the invention.

Alternatively, the routines of sub-routines do not have to be based on the field of the invention but on other defining characteristics of the invention. Examples of other defining characteristics could be, but not limited to, points of novelty, inventive step, utility, or subject matter.

The present invention may be engaged using any electronic means including, without limitation, personal computer, PDA, tablet, or another other device capable of engaging with a service provider in some manner. This can be done via either by a computer connected to the service provider's software, regardless if it is through a cable or wireless in the office of the service provider, on-line by connecting to the server of the service provider via the Internet, or via some cloud based system and the like.

The questions in the routine or sub-routine(s) can range from requesting specific information, to requesting the entry of general information and may include answering multiple choice questions of two or more options, depending on the characteristics of the routine being used. Any number of field of invention specific sub-routines are contemplated by the present invention and said sub-routines may relate to any field of invention which may include, without limitation:

pharmaceutical formulations,

pharmaceutical preparations,

pharmaceutical manufacturing methods,

software subroutines,

social networking architecture,

mechanical devices,

any other field of invention.

The self assembly software and the questions asked may be modified to reflect changes in patent law in any jurisdiction containing some form of patent law. For example, as the law changes either through statutory amendments or through case law, the questions may be modified to reflect such changes so that the self assembly reflects these changes.

The methods and processes contained herein may be implemented in computer hardware or software, or a combination of the two. They are not limited to any particular hardware or software configuration or processing environment that may be used. Preferably, the methods and processes are implemented in computer programs executing on programmable computer that each include a processor, a storage medium readable by the processor (possibly including volatile and non-volatile memory and/or storage elements), at least one input device, and one or more output devices. Program code may be applied to data entered using the input device to perform the functions described and to generate output information. The output information may be applied to the one or more output devices.

The disclosure of all patents, publications, including published patent applications, and database entries referenced in this specification are expressly incorporated by reference in their entirety to the same extent as if each such individual patent, publication, and database entry were expressly and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A process whereby a consumer of patent draft services engages a software means, follows a series of questions that once completed generates a draft patent application.

2. The process of claim 1 whereby the draft patent application is filed directly with a national patent office without further review.

3. The process of claim 1 whereby the draft patent application is filed with a national patent office upon further review by a patent drafting service provider.

4. The process of any one of claims 1 to 3 whereby a consumer of patent draft services engages a software means comprising:
a. a subroutine prompting the consumer to enter inventorship information regarding an invention;
b. a subroutine prompting the consumer to enter ownership information regarding the invention;
c. a subroutine prompting the consumer to enter information selecting a field or a plurality of fields of the invention, wherein the selection determines which field of invention specific subroutines will run subsequently;
d. a subroutine prompting the consumer to enter information regarding existing documents, the content of which relate to the selected field of invention and are similar to the invention;
e. a subroutine prompting the consumer to enter a description of the content of the existing documents and a description of a problem for which a solution cannot be found in the existing documents;
f. a subroutine prompting the consumer to enter a description of how the invention is different from the content of the existing documents; g. at least one field of invention specific subroutine;
wherein the entries of the consumer are analysed for grammatical structure and content and arranged within a pre-existing document to generate a substantially grammatically correct draft patent application.

5. The process of claim 4 wherein the field of invention specific subroutines prompts the consumer to enter:
a. a description of the essential elements of the invention;
b. a description of alternative means to achieve the invention;
c. a description of particular embodiments of the invention;
wherein sequence, wording or structure of the subroutine questions may vary depending on the field of invention or fields of invention selected.

6. A product produced by the process of any one of claims 1 to 5.
